(19) United States
(12) Patent Application Publication
(10) Pub. No.: US 2026/0008573 A1
(43) Pub. Date: Jan. 8, 2026

(54) CONTAINER-FEEDING DEVICE AND METHOD FOR FEEDING CONTAINERS TO A METERING AND/OR FILLING DEVICE, AND PRODUCTION MACHINE HAVING A CONTAINER-FEEDING DEVICE

(71) Applicant: Ampack GmbH, Königsbrunn (DE)

(72) Inventors: Michael Leutenmayr, Dinkelscherben (DE); Alois Sturm, Friedberg (DE)

(21) Appl. No.: 18/992,806

(22) PCT Filed: Jul. 25, 2023
(86) PCT No.: PCT/EP2023/070584

§ 371 Date: Jan. 9, 2025

(30) Foreign Application Priority Data
Jul. 25, 2022 (DE) 10 2022 118 573.7

(51) Int. Cl. B65B 43/52; B65G 65/23

(52) U.S. Cl. CPC B65B 43/52; B65G 65/23

(57) ABSTRACT

A container-feeding device, in particular a cup-feeding device, for a feeding of containers, in particular cups, to a metering and/or filling device, has at least one conveying unit including at least one conveying element, in particular a conveyor belt, for conveying at least one receiving container in which a plurality of, in particular stacked, containers is arranged. The container-feeding device includes at least one unloading unit for an at least partially, in particular completely, automatic unloading of the containers from the receiving container at least by a rotational movement of at least one rotatably supported holding element of the unloading unit, which is configured for, in particular temporarily, holding the receiving container, and/or at least by a movement of an, in particular translationally, movably supported release element of the unloading unit, which is configured for a release of an unloading opening of the receiving container.

### CROSS-REFERENCE TO RELATED APPLICATIONS

This patent application is a U.S. national stage application of international patent application PCT/EP2023/070584, filed on Jul. 25, 2023, which is based on and claims priority to German patent application DE 10 2022 118 573.7, filed on Jul. 25, 2022, the contents of which are incorporated herein by reference.

### BACKGROUND

The invention relates to a container-feeding device, in particular a cup-feeding device, for feeding containers, in particular cups, to a metering and/or filling device, with at least one conveying unit comprising at least one conveying element, in particular a conveyor belt, for conveying at least one receiving container in which a plurality of, in particular stacked, containers is arranged.

From DE 20 2013 004 063 U1, for example, a container-feeding device is known, wherein in the already known container-feeding device so-called cup stacks—i.e. cups stacked one inside the other—are filled manually by an operator into changer magazines of the container-feeding device, as a result of which contamination of the cup stacks, in particular on an inner face of an uppermost cup of the cup stacks or on an outer side of the cups of the cup stacks, may occur due to hand germs of the operator. Moreover, during the manual filling of the changing magazines, incorrect operation may occur due to incorrectly filled or unfilled cup stacks in the changer magazines, or there may be delay due to slow handling of the cup stacks by the operator, which may lead to an undesired dry run of a buffer store of the container-feeding device.

### SUMMARY

The objective of the invention is in particular to provide a generic container-feeding device, a generic production machine and/or a generic method, having improved properties with regard to process reliability and/or hygiene. The objective is achieved according to the invention.

The invention is based on a container-feeding device, in particular a cup-feeding device, for a feeding of containers, in particular cups, to a metering and/or filling device, with at least one conveying unit comprising at least one conveying element, in particular a conveyor belt, for conveying at least one receiving container in which a plurality of, in particular stacked, containers, preferably a plurality of cup stacks, are arranged.

It is proposed that the container-feeding device comprises at least one unloading unit for an at least partially, in particular completely, automatic unloading of the containers from the receiving container at least by a rotational movement of at least one rotatably supported holding element of the unloading unit, which is configured to, in particular temporarily, hold the receiving container, and/or at least by a movement of an, in particular translationally, movably supported release element of the unloading unit, which is configured for a release of an unloading opening of the receiving container. The implementation according to the invention advantageously allows realizing high process reliability, in particular due to the high degree of automation. Advantageously, hygienic loading of a magazine unit of a production machine comprising the container-feeding device is achievable, preferably since containers, in particular container stacks, preferably cup stacks, can be unloaded, particularly preferentially in a fully automated manner, from receiving containers realized, for example, as packaging means, in particular as shipping boxes and/or transport boxes, or the like. It is advantageously possible for a plurality of containers, in particular container stacks, preferably cup stacks, to be unloaded at the same time, in order to preferably enable time-optimized, and thus cost-optimized, unloading of the containers from the receiving container.

Preferentially the container-feeding device is configured for a feeding of cup stacks to the metering and/or filling device, in particular to a magazine unit of the metering and/or filling device. It is preferably possible that the cup stacks are singulated by means of a singulating unit of the metering and/or filling device, which is in particular arranged downstream of the magazine unit, in particular in order to feed individual cups of the cup stacks to a filling unit and to fill them individually with a product, in particular a food product, preferably in a manner already known to someone skilled in the art. “Configured” is in particular to mean specifically furnished, specifically designed, specifically equipped and/or specifically programmed. By an object being configured for a specific function is in particular to be understood that the object fulfils and/or carries out this specific function in at least one application state and/or operation state.

Preferably the conveying unit is configured for conveying a plurality of receiving containers, in which in each case a plurality of, in particular stacked, containers, preferably cup stacks, are arranged. Preferentially the individual cup stacks are arranged so as to be lying in the receiving containers, in particular with their longitudinal extension axis at least substantially oriented parallel to a container bottom. “Substantially parallel” is in particular to mean an orientation of a direction relative to a reference direction, in particular in a plane, wherein the direction differs from the reference direction in particular by less than 8°, advantageously by less than 5° and particularly advantageously by less than 2°. The receiving containers are preferably realized as, in particular polygonal, transport and/or delivery cartons. It is also conceivable that the receiving containers have a different implementation that is deemed expedient by someone skilled in the art, such as for example an implementation as a plastic crate, as a wooden box or the like. It is also conceivable that the containers are arranged within the receiving container in a protective cover, such as for example a plastic film or the like, or are arranged in the receiving container free of a protective cover. Preferably all containers, in particular cup stacks, disposed in a receiving container are arranged together in an, in particular separate, plastic sack that is preferably realized so as to be open on one side.

The conveying unit preferably comprises at least the conveying element for a conveying of a plurality of receiving containers. The conveying element is preferably realized as a conveyor belt that is drivable in a circulating manner. However, it is also conceivable that the conveying element has a different implementation deemed expedient by someone skilled in the art, such as for example an implementation as a conveyor chain, as an, in particular multi-axis, robot arm, as an electrodynamic conveying element or the like. The conveying unit may have a separate conveying element, which is in particular realized as a conveyor belt, or may have a plurality of conveying elements, which are in particular realized as conveyor belts, for conveying a plurality of receiving containers. The conveying unit may have lateral guide elements configured for lateral guidance of the receiving containers during conveying and/or configured for sub-dividing a conveying surface of the conveying element into separate conveying paths or for an, in particular spatial, separation of the plurality of conveying elements. Furthermore, the conveying unit may comprise at least one stopper element for a singulation of the receiving containers lined up on the conveying element or on the conveying elements. Preferably the conveying unit comprises a plurality of stopper elements which are configured for a singulation of the receiving containers lined up on the conveying element or on the conveying elements. The stopper element/s preferably has/have an implementation already known to someone skilled in the art. It is in particular possible that the receiving containers, preferably starting from a storage on a transport pallet, are fed manually by an operator to the conveying unit, in particular to the conveying element or the conveying elements. However, it is also conceivable that the receiving containers, preferably starting from a storage on a transport pallet, are fed to the conveying unit, in particular to the conveying element or the conveying elements, automatically by means of a handling unit, such as for example an, in particular multi-axis, robot arm or an autonomously acting robot or the like, which is advantageous in particular with regard to a degree of automation and/or hygiene. The conveying surface of the conveying element or of the conveying elements is preferably oriented at least substantially parallel to a horizontal plane and/or to a standing surface of a frame or of a standing base of the container feeding device, by means of which the weight forces of the container feeding device can be supported on a ground.

The unloading unit is preferably configured to automatically, in particular completely, unload the container/s, in particular the cup stacks, from the receiving container/s. Preferably the unloading unit can be loaded with at least one receiving container by means of a lift unit of the container-feeding device. It is preferentially possible that the receiving container, in particular in a state when arranged on the unloading unit, is fixed to the unloading unit by means of the holding element of the unloading unit. The holding element is preferably configured for a form-fitting and/or force-fitting fixing of the receiving container to the unloading unit. Preferably the holding element is realized as a clamping element. Preferentially the unloading unit comprises two holding elements, which are supported movably relative to each other and are configured for clamping at least one receiving container. The holding elements are preferably arranged mirror-symmetrically to each other. A clamping axis of the holding element/s, along which the holding elements are supported movably relative to each other, preferably extends at least substantially parallel to the conveying surface of the conveying element/s. It is also conceivable that the holding element/s has/have a different implementation deemed expedient by someone skilled in the art, such as for example an implementation as a vacuum gripper, as a clamping gripper, as a magnetic gripper or the like.

A rotary axis of the holding element/s, around which the holding element/s are supported rotatably, in particular for an unloading of the containers from the receiving container, preferably extends at least substantially parallel to the conveying surface of the conveying element/s. Preferentially the rotary axis of the holding element/s extends at least substantially parallel to the clamping axis of the holding element/s. The rotary axis of the holding element/s and/or the clamping axis of the holding element/s preferably extend/extends at least substantially parallel to the horizontal plane. However, it is also conceivable that the rotary axis of the holding element/s and/or the clamping axis of the holding element/s have/has a different orientation that is deemed expedient by someone skilled in the art.

Preferably the release element is realized as a slide which is configured, in particular in a state when the receiving container is clamped by the holding elements, to at least temporarily close, in particular cover, an open side of the receiving container, which preferentially forms the unloading opening of the receiving container. Preferentially the release element that is realized as a slide is configured to release, in particular to open, the open side of the receiving container, which preferentially forms the unloading opening of the receiving container, as a result of a movement of the release element, in particular relative to the receiving container and/or to the holding elements. The unloading unit may comprise a release element or a plurality of release elements, which is/are supported so as to be movable, in particular translationally movable, in particular for closing or releasing the unloading opening. A movement axis of the release element/s preferably extends at least substantially parallel to the conveying surface of the conveying element/s and/or to the horizontal plane. The movement axis of the release element/s preferably extends transversely, in particular at least substantially perpendicularly, to the rotary axis of the holding element/s and/or to the clamping axis of the holding element/s. The term “substantially perpendicularly” is in particular meant to define an orientation of a direction relative to a reference direction, wherein the direction and the reference direction, in particular when viewed in a projection plane, include an angle of 90° and the angle has a maximum deviation of in particular less than 8°, advantageously less than 5° and particularly advantageously less than 2°. The release element/s is/are preferably supported so as to be translationally movable along the movement axis of the release element/s. However, it is alternatively or additionally conceivable that the release element/s is/are supported so as to be rotationally movable around the movement axis of the release element/s.

For an at least partially, in particular completely, automatic unloading of the containers, in particular of the cup stacks, from the receiving container, it is for example conceivable that the receiving container is in an open state arranged on the conveying unit in particular with an open side, preferably with the open unloading opening. For example, in an open state the receiving container can in particular be fed to the unloading unit with the open side, preferably the unloading opening, oriented upwards. Preferably, the release element for example covers, in particular closes, the open side, in particular the unloading opening, in a state when the receiving container is held by the holding element. For example, in particular as a result of a rotational movement of the holding element, an orientation of the open side, in particular of the unloading opening, can be changed, in particular in such a way that the open side, in particular the unloading opening, is oriented downwards. For example, the open side, in particular the unloading opening, can be released as a result of a movement of the release element, in particular for an unloading of the containers, in particular the cup stacks, from the receiving container. Alternatively, it is also conceivable that the receiving container is arranged on the conveying unit in an open state, in particular with an open side, preferably with the open unloading opening, that the receiving container can be fed to the unloading unit with the open side, preferably the unloading opening, oriented upwards, that the receiving container can be held by the holding element and that-in particular only-as a result of a rotational movement of the holding element, in particular free of a movement of the release element, an orientation of the open side, in particular of the unloading opening, can be changed, in particular in such a way that the open side, in particular the unloading opening, is oriented downwards, in particular for an unloading of the containers, in particular the cup stacks, from the receiving container. Furthermore, it is alternatively conceivable that the at least one receiving container is arranged on the conveying unit so as to be, in particular completely, closed, that the receiving container can be fed to the unloading unit and can be opened by means of a cutting element of the unloading unit on a downwards-oriented side, in particular a bottom, preferably by making a cut, wherein the release element holds the side, in particular the bottom, closed and as a result of a movement, in particular a pivoting movement, of the release element, side portions, in particular bottom portions, which are created or released by the cut, can be moved away, in particular pivoted away, in particular in such a way that the open side, in particular the unloading opening, is created for an unloading of the containers, in particular the cup stacks, from the receiving container. It is conceivable that for moving away the side portions, in particular the bottom portions, at least one entrainment element, in particular at least one projection, such as for example hooks, claws or the like, or at least one vacuum gripper, is arranged on the release element for gripping and moving away the side portions, in particular the bottom portions, wherein the entrainment element may be supported movably on the release element or may be arranged rigidly on the release element. Further implementations and/or function modes of the unloading unit, deemed expedient by someone skilled in the art for an unloading of the containers, in particular the cup stacks, from the receiving container, are also conceivable.

The container-feeding device and/or the production machine preferably comprise/comprises at least one control or regulation unit, which is furnished for controlling or regulating the conveying unit, the unloading unit and/or further units of the container-feeding device and/or the production machine. A “control or regulation unit” is in particular to mean a unit with at least one control electronics unit. A “control electronics unit” is in particular to mean a unit with a processor unit and with a memory unit as well as with an operating program stored in the memory unit. The container-feeding device and/or the production machine comprise/comprises at least one sensor unit, the signals of which can be processed by the control or regulation unit at least for a controlling or regulation of the conveying unit, the unloading unit and/or the further units. The unloading unit preferably comprises at least one drive unit for driving the holding element and/or the release element. Preferably the drive unit of the unloading unit can be controlled or regulated by means of the control or regulation unit.

It is further proposed that the container-feeding device comprises at least one distributor unit, which is configured to divide up containers supplied via an unloading unit, in particular via the aforementioned unloading unit, wherein the distributor unit comprises a plurality of chute elements which are configured for a guidance of the containers, or wherein the distributor unit comprises at least one storage element, which is supported movably, in particular pivotably, and which in at least one position of the storage element interacts with an output element of the distributor unit. It is conceivable that for the purpose of solving the above-mentioned task, the container-feeding device is in an alternative implementation realized independently of the rotatably supported holding element and/or of the movably supported release element of the unloading unit. Preferably, in the alternative implementation, in particular in the implementation realized independently of the rotatably supported holding element and/or of the movably supported release element of the unloading unit, the container-feeding device includes at least the conveying unit comprising at least the conveying element, in particular a conveyor belt, for conveying at least one receiving container in which a plurality of, in particular stacked, containers is arranged, and includes at least the distributor unit, which is configured to divide containers supplied via an unloading unit, wherein the distributor unit comprises a plurality of chute elements which are configured for a guidance of the containers, or wherein the distributor unit comprises at least one storage element, which is supported movably, in particular pivotably, and which in at least one position of the storage element interacts with an output element of the distributor unit. Preferably the chute elements are configured to delimit individual receiving spaces of the distributor unit into which the containers, in particular the cup stacks, can be fed by means of the unloading unit. Preferentially the containers, in particular the cup stacks, can be subdivided into individual stacks by means of the chute elements already during a transfer from the unloading unit. Preferably the containers, in particular the cup stacks, can be stacked in the chute elements, in particular along a vertical axis of the distributor unit. In particular, the chute elements can be closed or opened at least on a side, in particular on a side facing away from the unloading unit, by means of at least one singulating element, in particular a plurality of singulating elements. The singulating element is preferably realized as a singulating flap. However, it is also conceivable that the singulating element has a different implementation deemed expedient by someone skilled in the art, in particular an implementation by means of which containers, in particular cup stacks, can be transferred individually from the respective receiving space. The singulating elements are preferably realized so as to be at least substantially identical to each other. In particular, the singulating element/s is/are supported so as to be, in particular translationally and/or rotationally, movable relative to the chute elements. The singulating element/s is/are configured to delimit, preferably predetermine, a stack length within the chute elements. The chute elements preferably comprise slot-link guide elements, in particular slot-link guide grooves, depending on which the singulating element/s is/are movable, in particular pivotable. The singulating element/s is/are preferably movable within the chute element/s, in particular by the slot-link guide elements, translationally along a direction that runs at least substantially perpendicular to the conveying surface of the conveying element/s within the chute element/s. Preferably at least one, preferably two, singulating element/s is/are allocated to each of the receiving spaces. In particular, the singulating element/s and the chute element/s together form something like a container lifting unit, in particular a cup stack lifting unit, by means of which the containers, in particular the cup stacks, can be moved in the distributor unit along the vertical axis.

Preferably, in particular in an alternative implementation of the distributor unit in which the distributor unit is preferably realized free of the chute elements, the output element is realized as a lifting table that is supported so as to be movable, in particular translationally movable, within the distributor unit. The storage element is preferably supported movably, in particular translationally movably, along a lifting axis of the storage element that runs at least substantially perpendicular to the horizontal plane. Alternatively or additionally, the storage element is supported so as to be pivotably movable, in particular around a pivot axis of the storage element that extends at least substantially parallel to the horizontal plane. In particular, the containers, in particular the cup stacks, can be fed, preferably directly, to the storage element by the unloading unit. Preferably the containers, in particular the cup stacks, can be unloaded on the storage element by the unloading unit, preferably all containers, in particular all cup stacks, can be unloaded from a single receiving container. The output element is preferably realized as an output chute. In particular, at least one singulating element, preferably a singulating flap, of the distributor unit is arranged on the output element. The singulating element is preferably configured to individually discharge containers, in particular cup stacks, from the output element. Further implementations of the distributor unit, deemed expedient by someone skilled in the art, for a singulation of the containers, in particular cup stacks, that are supplied by means of the unloading unit, are also conceivable. The distributor unit preferably comprises at least one drive unit for driving the storage element and/or the singulating element. Preferably the drive unit of the distributor unit can be controlled or regulated by means of the control or regulation unit. The implementation according to the invention advantageously allows realizing high process reliability, in particular due to the high degree of automation. Advantageously, hygienic loading of a magazine unit of a production machine comprising the container-feeding device is achievable, preferably since containers, in particular container stacks, preferably cup stacks, can be unloaded, particularly preferentially in a fully automated manner, from receiving containers realized, for example, as packaging means, in particular as shipping boxes and/or transport boxes, or the like. It is advantageously possible for a plurality of containers, in particular container stacks, preferably cup stacks, to be unloaded at the same time, such that preferably time-optimized, and thus cost-optimized, unloading of the containers from the receiving container is enabled. Advantageously, fully automated loading of a magazine unit with containers, in particular container stacks, preferably cup stacks, is enabled.

It is further proposed that the container-feeding device comprises at least one bearing unit, in particular a linear bearing unit, for an, in particular translationally, movable support of the unloading unit, in particular along a movement axis of the unloading unit that runs at least substantially parallel to a conveying surface of the conveying element, wherein the unloading unit is supported by the bearing unit so as to be movable at least from a loading position of the unloading unit to an unloading position of the unloading unit. The bearing unit preferably comprises at least one guide element, in particular at least one linear guide element, for guiding a movement of the unloading unit relative to a frame of the container-feeding device and/or relative to the conveying unit along and/or around the movement axis of the unloading unit. The guide element may be realized as a slide bearing, as a roller bearing, as a fluidic bearing, or the like. In at least one implementation of the bearing unit, the guide element is preferably realized as a linear guide carriage. However, it is also conceivable that the guide element has a different implementation deemed expedient by someone skilled in the art, in particular an implementation expedient with respect to a type of the movement that is to be guided. The bearing unit is preferably configured for a conjoint movement of the holding element and the release element, preferably along a frame of the unloading unit, in a horizontal plane, in particular for a movement of the unloading unit from a position above the conveying element to a position above the distributor unit. The bearing unit preferably comprises at least one drive unit for moving the unloading unit along the movement axis of the unloading unit. Preferably the drive unit of the bearing unit can be controlled or regulated by means of the control or regulation unit. The implementation according to the invention advantageously allows achieving a high degree of automation. Advantageously, reliable and automatic transport of the containers, in particular the cup stacks, to the distributor unit is enabled. Advantageously, reliable loading of a magazine unit with containers, in particular cup stacks, is enabled. Advantageously, a machine stop due to dry run of a magazine unit can be counteracted.

Moreover, it is proposed that the container-feeding device comprises at least one lifting unit, which is configured to movably support the unloading unit along a vertical direction or which comprises at least one movably supported lifting element that is configured to transfer the receiving container from the conveying element to the holding element. In an implementation of the container-feeding device, the lifting unit may be configured to support the entire unloading unit, in particular the holding element together with the release element, such that it is movable along the vertical direction, in particular for the purpose of removing receiving containers directly from the conveying unit by means of the holding element/s. In an alternative implementation, the lifting unit may comprise at least one lifting element which is supported movably along the vertical direction and which is configured to transfer the receiving container from the conveying element to the holding element. The lifting unit preferably comprises at least one drive unit for driving the lifting element or the unloading unit along the vertical direction. Preferably the drive unit of the lifting unit can be controlled or regulated by means of the control or regulation unit. The lifting element is preferably supported so as to be movable along the vertical direction in a driven manner. The lifting element or the entire unloading unit is preferably movable in a back-and-forth movement along and against the vertical direction. Preferably, after a transport of a receiving container along the vertical direction, the lifting element or the entire unloading unit is movable against the vertical direction towards the conveying unit. The lifting unit may comprise a plurality of lifting elements by means of which the unloading unit can be loaded alternatingly with receiving containers or by means of which each of a plurality of unloading units can be loaded with a receiving container. The vertical direction preferably extends transversely, in particular at least substantially perpendicularly, to the conveying surface of the conveying element. The lifting plane of the lifting unit preferably extends transversely, in particular at least substantially perpendicularly, to the horizontal plane. The implementation according to the invention advantageously allows realizing high process reliability, in particular due to the high degree of automation. Advantageously fully automated, secure and time-optimized unloading of containers, in particular cup stacks, from receiving containers is achievable.

Beyond this, it is proposed that the container-feeding device comprises a distributor unit, in particular the aforementioned distributor unit, which is configured to divide up containers supplied by the unloading unit, wherein viewed along a container transport flow, the unloading unit is arranged downstream of the conveying unit and upstream of the distributor unit. In particular, the container transport flow extends from the conveying unit to the lifting unit via the unloading unit to the distributor unit. Upstream of the distributor unit the containers, in particular the cup stacks, are transported along the container transport flow to a magazine unit and/or to the metering and/or filling device, preferably via further transport units that are at least partly known to someone skilled in the art. Preferably the unloading unit is arranged in a plane above the conveying unit. Preferably the distributor unit is arranged laterally offset from the conveying unit. However, it is also conceivable that the conveying unit, the unloading unit and the distributor unit have a different arrangement and/or positioning deemed expedient by someone skilled in the art. It is advantageously possible that a compact implementation of the container-feeding device with a high degree of automation is enabled.

Furthermore, a production machine with at least one metering and/or filling device and with at least one container-feeding device according to the invention is proposed. The production machine may comprise further devices and/or units which are deemed expedient by someone skilled in the art and which are usable for a handling, for a filling and/or for a manufacturing of products, in particular food products. The production machine is preferably configured for a manufacturing, filling, packaging and/or secondary packaging of food products. In addition to the metering and/or filling device and/or the container-feeding device, the production machine may comprise a plurality of further devices and/or units deemed expedient by someone skilled in the art, such as for example a forming device for packagings, a cutting device, a filling device, a sterilization device, a closure device, a secondary-packaging device or the like. The implementation according to the invention advantageously allows achieving high process reliability during a manufacturing, filling, packaging and/or secondary packaging of products, in particular food products, by the production device. Advantageously, hygienic loading of a magazine unit of a production machine comprising the container-feeding device is achievable, preferably since containers, in particular container stacks, preferably cup stacks, can be unloaded, particularly preferentially in a fully automated manner, from receiving containers realized, for example, as packaging means, in particular as shipping boxes and/or transport boxes, or the like. It is advantageously possible for a plurality of containers, in particular container stacks, preferably cup stacks, to be unloaded at the same time, such that preferably time-optimized, and thus cost-optimized, unloading of the containers from the receiving container is enabled.

The invention is moreover based on a method for feeding containers, in particular cups, to a metering and/or filling device, in particular of the production machine, by a container-feeding device, in particular by a container-feeding device according to the invention. It is proposed that in at least one method step, by means of at least one unloading unit of the container-feeding device, an at least partially, in particular completely, automatic unloading of the containers from the receiving container is realized at least by a rotational movement of a holding element of the unloading unit that, in particular temporarily, holds the receiving container, and/or at least by a movement of a release element of the unloading unit that in at least one state covers an unloading opening of the receiving container. In particular, in at least one method step of the method according to the invention, preferably starting from a storage on a transport pallet, the receiving containers are fed manually by an operator to the conveying unit, in particular to the conveying element/s. However, it is also conceivable that in at least one method step of the method according to the invention, preferably starting from a storage on a transport pallet, the receiving containers are fed to the conveying unit, in particular to the conveying element/s, automatically by means of a handling unit, for example by an, in particular multi-axis, robot arm or by an autonomously acting robot or the like, which is advantageous in particular with regard to a degree of automation and/or to hygiene. Preferably, in at least one method step of the method according to the invention, the receiving containers are conveyed towards the unloading unit and/or towards the lifting unit. Preferably, in at least one method step of the method according to the invention, a singulation of the receiving containers situated on the conveying element/s is realized by means of the at least one stopper element of the conveying unit. In at least one method step of the method according to the invention, the receiving containers are preferably transferred to the unloading unit, in particular by the lifting unit. Preferably, in at least one method step of the method according to the invention, an unloading of the containers, in particular cup stacks, that are arranged in the receiving containers is realized by means of the unloading unit. Preferably in at least one method step of the method according to the invention, a transfer of the containers, in particular cup stacks, to the distributor unit is realized, in particular as a result of the unloading by the unloading unit. The implementation according to the invention advantageously allows realizing high process reliability, in particular due to the high degree of automation. It is advantageously possible to achieve hygienic loading of a magazine unit of a production machine comprising the container-feeding device, preferably since containers, in particular container stacks, preferably cup stacks, can be unloaded, particularly preferentially in a fully automated manner, from receiving containers which are embodied, for example, as packaging means, in particular as shipping boxes and/or transport boxes, or the like. It is advantageously possible for a plurality of containers, in particular container stacks, preferably cup stacks, to be unloaded at the same time, such that preferably time-optimized, and thus cost-optimized, unloading of the containers from the receiving container is enabled.

In addition, it is proposed that in at least one method step of the method according to the invention, the containers supplied via an unloading unit, in particular the aforementioned unloading unit, are divided up by means of at least one distributor unit, in particular the aforementioned distributor unit, of the container-feeding device, wherein as a result of an unloading by the unloading unit, the containers are fed to a plurality of chute elements of the distributor unit, in particular the aforementioned chute elements, which are configured for a guidance of the containers, or wherein after an unloading by means of the unloading unit, the containers are fed to an output element of the distributor unit, in particular the aforementioned output element, by means of at least one pivotably supported storage element of the distributor unit, in particular the aforementioned storage element. It is conceivable that for the purpose of solving the above-mentioned task, the method is in an alternative implementation realized independently of the rotational movement of the holding element and/or of the movement of the release element of the unloading unit. Preferably, in the alternative implementation, in particular in the implementation realized independently of the rotational movement of the holding element and/or of the movement of the release element of the unloading unit, the method comprises at least the method steps in which the containers supplied via an unloading unit are divided up by means of at least one distributor unit of the container-feeding device, wherein as a result of an unloading by the unloading unit, the containers are fed to a plurality of chute elements of the distributor unit which are configured for a guidance of the containers, or wherein after an unloading by the unloading unit, the containers are fed to an output element of the distributor unit by means of at least one pivotably supported storage element of the distributor unit. The implementation according to the invention advantageously allows realizing high process reliability, in particular due to the high degree of automation. Advantageously, hygienic loading of a magazine unit of a production machine comprising the container-feeding device is achievable, preferably since containers, in particular container stacks, preferably cup stacks, can be unloaded, particularly preferentially in a fully automated manner, from receiving containers realized, for example, as packaging means, in particular as shipping boxes and/or transport boxes, or the like. It is advantageously possible for a plurality of containers, in particular container stacks, preferably cup stacks, to be unloaded at the same time, such that preferably time-optimized, and thus cost-optimized, unloading of the containers from the receiving container is enabled. Advantageously, fully automated loading of a magazine unit with containers, in particular container stacks, preferably cup stacks, is enabled.

Beyond this, it is proposed that in at least one method step of the method according to the invention, the unloading unit is moved at least from a loading position of the unloading unit to an unloading position of the unloading unit by means of at least one bearing unit, in particular the aforementioned bearing unit, in particular along a movement axis of the unloading unit, in particular the aforementioned movement axis of the unloading unit, which runs at least substantially parallel to a conveying surface, in particular the aforementioned conveying surface, of the conveying element. Preferentially the unloading unit is moved by the drive unit fully automatically from the loading position of the unloading unit to the unloading position of the unloading unit and vice versa. The implementation according to the invention advantageously allows achieving a high degree of automation. Advantageously, reliable and automatic transport of the containers, in particular the cup stacks, to the distributor unit is enabled. Advantageously, reliable loading of a magazine unit with containers, in particular cup stacks, is enabled. Advantageously, a machine stop due to dry run of a magazine unit can be counteracted.

It is moreover proposed that in at least one method step of the method according to the invention, the containers are fed-by means of a feeding-conveying unit, in particular a transverse conveying unit, of the container-feeding device-to a magazine unit of the container-feeding device, which is pivoted by more than 45° relative to a horizontal plane, in particular the aforementioned horizontal plane. Preferably, after being loaded with containers, in particular cup stacks, the magazine unit is pivoted relative to the horizontal plane by in particular more than 60°, preferably by more than 75° and particularly preferably by at least 90°. The magazine unit and/or the transverse conveying unit may have an implementation already known to someone skilled in the art. Preferentially the distributor unit is in terms of conveying technology connected to the transverse conveying unit via an ascending conveying unit of the container-feeding device. The ascending conveying unit is preferably realized as an ascending conveyor belt. However, it is also conceivable that the ascending conveying unit has a different implementation deemed expedient by someone skilled in the art. Preferably the ascending conveying unit has an implementation already known to someone skilled in the art. The implementation according to the invention advantageously allows achieving a high degree of automation. Advantageously, reliable transfer of a high number of containers, in particular cup stacks, to the metering and/or filling device is achievable.

The container-feeding device according to the invention, the production machine according to the invention and/or the method according to the invention shall here not be limited to the application and implementation described above. In particular, in order to fulfil a functionality that is described here, the container-feeding device according to the invention, the production machine according to the invention and/or the method according to the invention may have a number of individual elements, components and units as well as method steps that differs from a number given here. Moreover, with regard to the value ranges indicated in this disclosure, values situated within the mentioned limits shall also be considered to be disclosed and usable as desired.

### BRIEF DESCRIPTION OF THE DRAWINGS

Further advantages will become apparent from the following description of the drawings. Two exemplary embodiments of the invention are illustrated in the drawings. The drawings, the description and the claims contain numerous features in combination. Someone skilled in the art will purposefully also consider the features individually and will find further expedient combinations.

In the drawings:

FIG. 1 shows a production machine according to the invention with at least one container-feeding device according to the invention in a schematic illustration,

FIG. 2 shows a detailed view of the container-feeding device according to the invention in a schematic illustration,

FIG. 3a shows a detailed view of an unloading unit of the container-feeding device according to the invention and a receiving container arranged thereon with an upwards-oriented unloading opening in a schematic illustration,

FIG. 3b shows a detailed view of the unloading unit of the container-feeding device according to the invention and the receiving container arranged thereon with the downwards-oriented unloading opening in a schematic illustration,

FIG. 4a shows a detailed view of a distributor unit of the container-feeding device according to the invention in a schematic illustration,

FIG. 4b shows a detailed view of an alternative distributor unit of the container-feeding device according to the invention in a schematic illustration,

FIG. 5 shows a detailed view of a feed conveying unit and a magazine unit of the container-feeding device according to the invention in a schematic illustration, and

FIG. 6 shows a schematic process flow of a method according to the invention in a schematic illustration.

### DETAILED DESCRIPTION

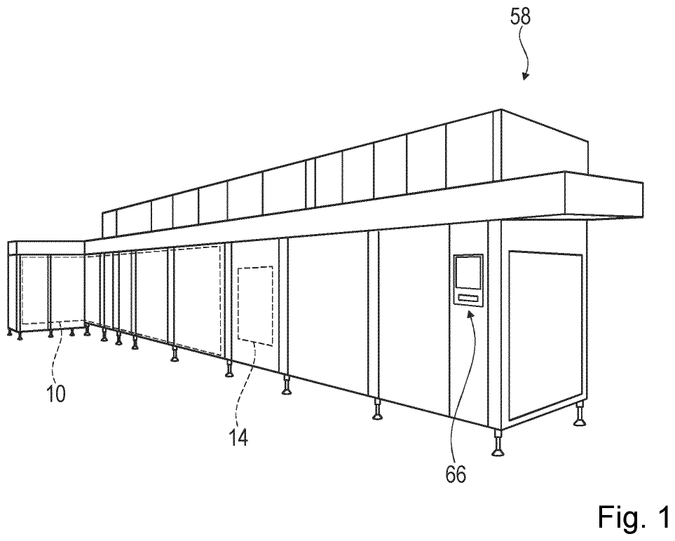

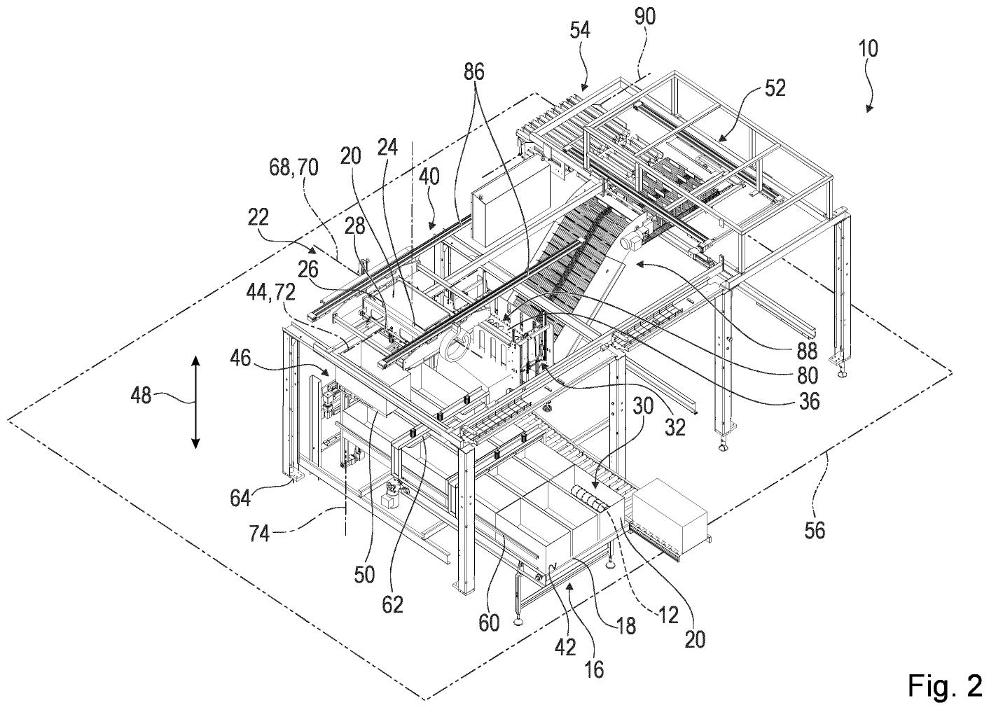

FIG. 1 shows a production machine 58 comprising at least one metering and/or filling device 14 and at least one container-feeding device 10 for a feeding of containers 12 (cf. FIG. 2, illustrated by dashed lines), in particular cups, to the metering and/or filling device 14. Preferably the metering and/or filling device 14 is configured for a filling of containers 12 with products, in particular food products. The production machine 58 is preferably configured for a manufacturing, filling, packaging and/or secondary packaging of food products. Preferentially the production machine 58 is configured at least for filling food products into containers 12. The production machine 58 may be realized, for example, as a food packaging machine, as a food filling machine, as a food production machine, as a combination of the aforementioned machines, or the like. The production machine 58 may comprise further devices and/or units which are deemed expedient by someone skilled in the art and are used for a manufacturing and/or processing of products, in particular food products, such as for example a further transport device, a sterilization device, a closure device, a secondary-packaging device or the like. The container-feeding device 10 and/or the production machine 58 preferably comprise/comprises at least one control or regulation unit 66, which is configured for controlling or regulating units of the container-feeding device 10 and/or devices of the production machine 58.

FIG. 2 shows the container-feeding device 10 in a representation independently of other devices of the production machine 58. The container-feeding device 10 is preferably realized as a cup-feeding device. Preferably the container-feeding device 10 is configured for a feeding of cups, in particular cup stacks, to the metering and/or filling device 14. However, it is also conceivable that the container-feeding device 10 has a different implementation deemed expedient by someone skilled in the art and is configured for a feeding of different types of containers 12, such as for example trays, cartons or the like, in particular of stacked trays, cartons or the like. The container-feeding device 10 includes at least one conveying unit 16 comprising at least one conveying element 18, in particular a conveyor belt, for a conveying of at least one receiving container 20 in which a plurality of, in particular stacked, containers 12 are arranged. Preferably the conveying unit 16 is configured for a conveying of a plurality of receiving containers 20 in each of which a plurality of, in particular stacked, containers 12, preferably cup stacks, are arranged. Preferentially the individual cup stacks are arranged so as to be lying in the receiving containers 20, in particular with their longitudinal extension axis oriented at least substantially parallel to a container bottom, in particular in a manner already known to someone skilled in the art. The receiving containers 20 are preferably realized as, in particular polygonal, transport and/or delivery cartons. It is also conceivable that the receiving containers 20 have a different implementation deemed expedient by someone skilled in the art, such as for example an implementation as a plastic crate, as a wooden box or the like. It is also conceivable that the containers 12, in particular the cup stacks, are arranged within the receiving container 20—In a manner already known to someone skilled in the art—In a protective envelope, for example a plastic film or the like, or that they are arranged in the receiving container 20 free of a protective envelope. Preferably all containers 12, in particular cup stacks, arranged in a receiving container 20 are—In a manner already known to someone skilled in the art—arranged together in a plastic sack, in particular one single plastic sack, which is preferably realized so as to be open on one side.

The conveying unit 16 preferably comprises at least the conveying element 18 for a conveying of a plurality of receiving containers 20. The conveying element 18 is preferably realized as a conveyor belt that is drivable in a circulating manner. However, it is also conceivable that the conveying element 18 has a different implementation deemed expedient by someone skilled in the art, such as for example an implementation as a conveyor chain, as an, in particular multi-axis, robot arm, as an electrodynamic conveying element or the like. The conveying unit 16 may comprise a single conveying element 18, which is in particular embodied as a conveyor belt, or may have a plurality of conveying elements 18, which are in particular embodied as conveyor belts, for conveying a plurality of receiving containers 20. The conveying unit 16 may comprise lateral guide elements 60 (in FIG. 2 two lateral guide elements 60 realized as peripheral boundaries are shown), which are configured for a lateral guidance of the receiving containers 20 during conveying and/or which are configured for sub-dividing a conveying surface 42 of the conveying element 18 into separate conveying paths or for an, in particular spatial, separation of the plurality of conveying elements 18. The conveying unit 16 may further comprise at least one stopper element 62 for singulating the receiving containers 20 lined up on the conveying element/s 18. Preferably the conveying unit 16 comprises a plurality of stopper elements 62, which are configured for singulating the receiving containers 20 lined up on the conveying element/s 18. The stopper element/s 62 preferably has/have an implementation already known to someone skilled in the art. In particular, preferably starting from a storage on a transport pallet (not shown here in detail), the receiving containers 20 can be fed manually by an operator to the conveying unit 16, in particular to the conveying element/s 18. However, it is also conceivable that, preferably starting from a storage on a transport pallet, the receiving containers 20 can be fed to the conveying unit 16 automatically by means of a handling unit, for example an, in particular multi-axis, robot arm or an autonomously acting robot or the like. The conveying surface 42 of the conveying element/s 18 is preferably oriented at least substantially parallel to a horizontal plane 56 and/or to a standing surface 64 of a frame or of a standing base of the container feeding device 10, by means of which the weight forces of the container feeding device 10 can be supported on a ground.

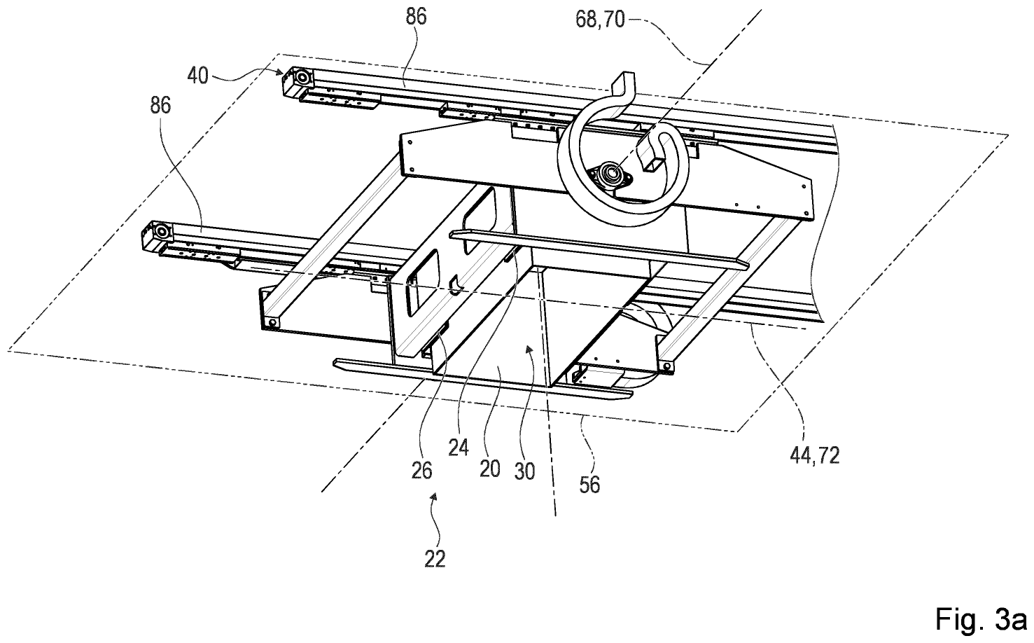

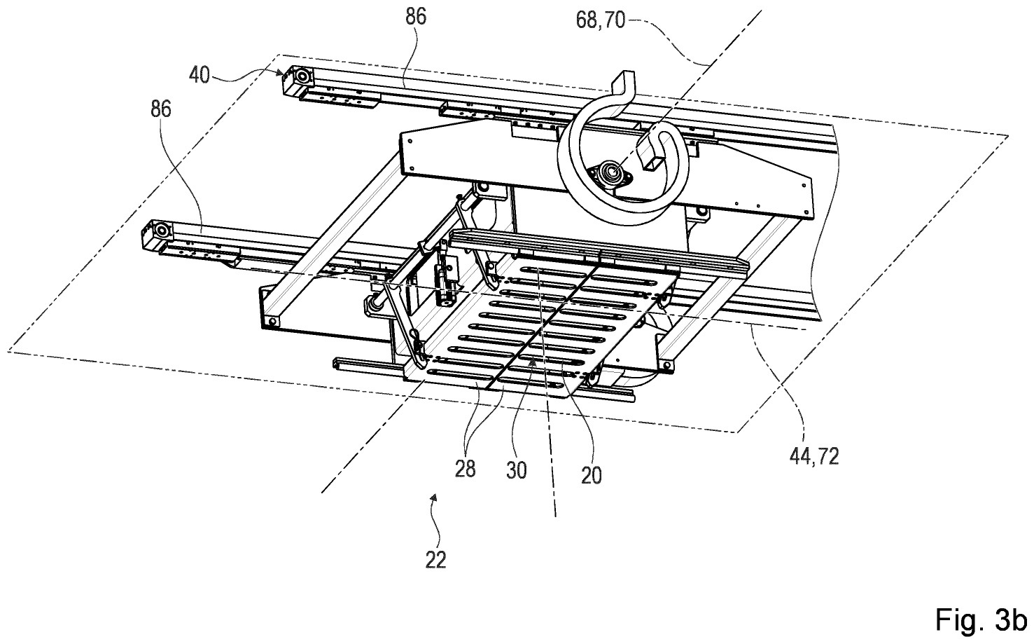

The container-feeding device 10 further comprises at least one unloading unit 22 for an at least partially, in particular completely, automatic unloading of the containers 12 from the receiving container 20 at least by a rotational movement of at least one rotatably supported holding element 24, 26 of the unloading unit 22 which is configured for, in particular temporarily, holding the receiving container 20, and/or at least by a movement of an, in particular translationally, movably supported release element 28 of the unloading unit 22, which is configured for a release of an unloading opening 30 of the receiving container 20 (cf. also FIGS. 3a and 3b).

The unloading unit 22 is preferably configured to automatically, in particular completely, unload the container/s 12, in particular the cup stacks, from the receiving container/s 20. Preferably the unloading unit 22 can be loaded with at least one receiving container 20 by means of a lifting unit 46 of the container-feeding device 10. Preferably the receiving container 20, in particular in a state when arranged on the unloading unit 22, can be held at the unloading unit 22 by means of the holding element 24, 26 of the unloading unit 22. The holding element 24, 26 is preferably configured for a form-fitting and/or force-fitting holding of the receiving container 20 at the unloading unit 22. Preferably the holding element 24, 26 is realized as a clamping element. Preferentially the unloading unit 22 comprises two holding elements 24, 26, which are supported movably relative to each other and are configured for clamping at least one receiving container 20. The holding elements 24, 26 are preferably arranged mirror-symmetrically to each other. A clamping axis 68 (cf. also FIGS. 3a and 3b) of the holding element/s 24, 26, along which the holding elements 24, 26 are supported movably relative to each other, preferably extends at least substantially parallel to the conveying surface 42 of the conveying element/s 18. It is also conceivable that the holding element/s 24, 26 has/have a different implementation deemed expedient by someone skilled in the art, such as for example an implementation as a vacuum gripper, as a clamping gripper, as a magnetic gripper or the like.

A rotary axis 70 of the holding element/s 24, 26, around which the holding element/s 24, 26 are supported rotatably, in particular for an unloading of the containers 12 from the receiving container 20, preferably extends at least substantially parallel to the conveying surface 42 of the conveying element/s 18. Preferably the rotary axis 70 of the holding element/s 24, 26 extends at least substantially parallel to, in particular coaxially with, the clamping axis 68 of the holding element/s 24, 26. The rotary axis 70 of the holding element/s 24, 26 and/or the clamping axis 68 of the holding element/s 24, 26 preferably extend/extends at least substantially parallel to the horizontal plane 56. However, it is also conceivable that the rotary axis 70 of the holding element/s 24, 26 and/or the clamping axis 68 of the holding element/s 24, 26 have/has a different orientation deemed expedient by someone skilled in the art. In FIG. 3a the unloading unit 22 is illustrated with a receiving container 20 arranged thereon with a downwards-oriented unloading opening 30 of the receiving container 20, wherein the release element 28 is not shown in FIG. 3a. In FIG. 3b the unloading unit 22 is illustrated with the receiving container 20 arranged thereon with the downwards-oriented unloading opening 30, wherein the unloading opening 30 is covered, in particular closed, by the release element 28. During loading with a receiving container 20, the unloading unit 22 is rotated by 180° as compared to the orientation illustrated in FIGS. 2, 3a and 3b, in particular as a result of a 180°-rotation of the release element 28 together with the holding element/s 24, 26 around the rotary axis 70 of the holding element/s 24, 26.

Preferably the release element 28 is realized as a slide configured, in particular in a state when the receiving container 20 is clamped by the holding element/s 24, 26, to at least temporarily close, in particular cover, an open side of the receiving container 20, which preferentially forms the unloading opening 30 of the receiving container 20. However, it is also conceivable that the release element 28 has a different implementation deemed expedient by someone skilled in the art, such as for example an implementation as a flap, as a lock, as a rotary opener or the like. Preferably the release element 28 that is realized as a slide is configured, as a result of a movement of the release element 28, in particular relative to the receiving container 20 and/or to the holding element/s 24, 26, to release, in particular to open, the open side of the receiving container 20 which preferentially forms the unloading opening 30 of the receiving container 20. The unloading unit 22 may comprise a single release element 28 or a plurality of release elements 28, which is/are supported so as to be movable, in particular translationally movable, in particular for closing or releasing the unloading opening 30. A movement axis 72 of the release element/s 28 for releasing or covering the unloading opening 30 preferably extends at least substantially parallel to the conveying surface 42 of the conveying element/s 18 and/or to the horizontal plane 56. The movement axis 72 of the release element/s 28 preferably runs transversely, in particular at least substantially perpendicularly, to the rotary axis 70 of the holding element/s 24, 26 and/or to the clamping axis 68 of the holding element/s 24, 26. The release element/s 28 is/are preferably supported so as to be translationally movable along the movement axis 72 of the release element/s 28. However, it is alternatively or additionally conceivable that the release element/s 28 is/are supported so as to be rotationally movable around the movement axis 72 of the release element/s 28.

For an at least partially, in particular completely, automatic unloading of the containers 12, in particular the cup stacks, from the receiving container 20, it is for example conceivable that the receiving container 20 is in an open state arranged on the conveying unit 16, in particular with an open side, preferably with the open unloading opening 30. For example, the receiving container 20 can be fed to the unloading unit 22 in an open state, in particular with the open side, preferably the open unloading opening 30, oriented upwards. For example, the release element/s 28 preferably covers, in particular closes, the open side, in particular the unloading opening 30, in a state when the receiving container 20 is held by the holding element/s 24, 26 (cf. FIG. 3b). For example, in particular as a result of a rotational movement of the unloading unit 22, in particular of the release element 28 together with the holding element/s 24, 26, an orientation of the open side, in particular of the unloading opening 30, can be changed, in particular in such a way that the open side, in particular the unloading opening 30, is oriented downwards (cf. FIG. 2). For example, the open side, in particular the unloading opening 30, can be released as a result of an, in particular translational, movement of the release element/s 28, in particular for an unloading of the containers 12, in particular the cup stacks, from the receiving container 20.

Alternatively, in particular in an implementation in which the unloading opening 30 cannot be closed by means of the release element/s 28, preferably in a state when the unloading unit 22 is realized free of the release element/s 28, it is also conceivable that the receiving container 20 is in an open state arranged on the conveying unit 16, in particular with an open side, preferably with the open unloading opening 30 oriented upwards, that the receiving container 20 can be fed to the unloading unit 22 with the open side, preferably the unloading opening 30, oriented upwards, that the receiving container 20 can be held by the holding element/s 24, 26 and that, in particular only, as a result of a rotational movement of the holding element/s 24, 26, in particular free of a movement of the release element/s 28, an orientation of the open side, in particular of the unloading opening 30, can be changed, in particular in such a way that the open side, in particular the unloading opening 30, is oriented downwards, in particular for an unloading of the containers 12, in particular the cup stacks, from the receiving container 20.

Furthermore, it is alternatively conceivable that the at least one receiving container 20 is arranged on the conveying unit 16 so as to be, in particular completely, closed, that the receiving container 20 can be fed to the unloading unit 22 and can be opened by means of a cutting element (not shown here in detail) of the unloading unit 22 on a downwards-oriented side, in particular a bottom, preferably by making a cut, wherein the release element/s 28 holds/hold the side, in particular the bottom, closed and as a result of a movement, in particular a pivoting movement, of the release element/s 28, side portions, in particular bottom portions, of the receiving container 20, which have been created or released by the cut, can be moved away, in particular pivoted away, in particular such that the open side, in particular the unloading opening 30, is created for an unloading of the containers 12, in particular the cup stacks, from the receiving container 20. It is conceivable that for moving away the side portions, in particular the bottom portions, at least one entrainment element, in particular at least one projection, for example a hook, a claw or the like, or at least one vacuum gripper, is arranged on the release element/s 28 for gripping and moving away the side portions, in particular the bottom portions, wherein the entrainment element may be supported movably on the release element/s 28 or may be arranged rigidly on the release element/s 28. Further implementations and/or function modes of the unloading unit 22, deemed expedient by someone skilled in the art, for an unloading of the containers 12, in particular the cup stacks, from the receiving container 20 are also conceivable.

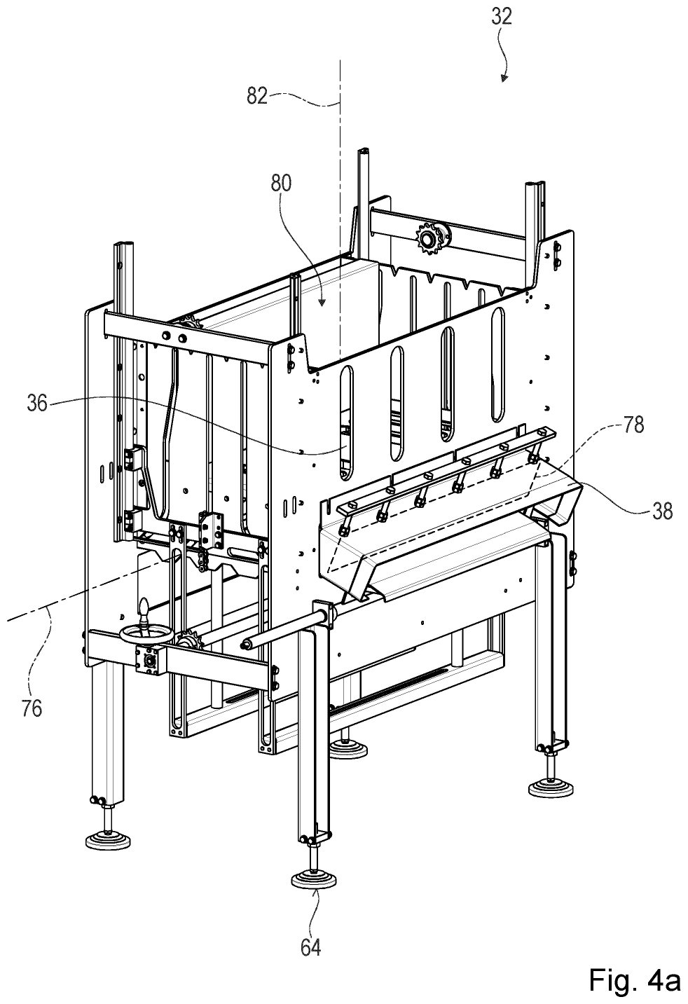

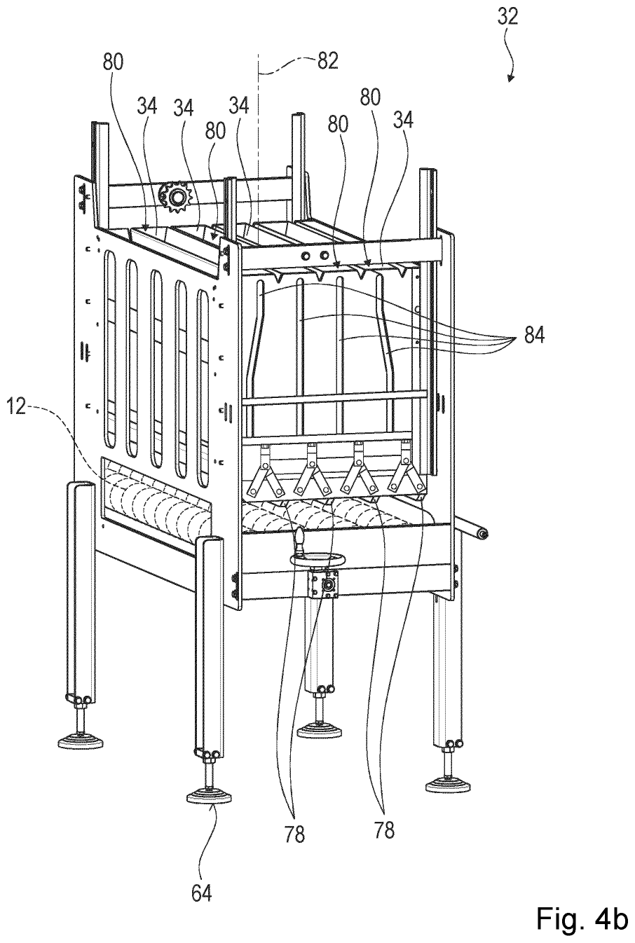

In addition, the container-feeding device 10 preferably comprises at least one distributor unit 32, which is configured to divide up containers 12 supplied via the unloading unit 22, wherein the distributor unit 32 comprises a plurality of chute elements 34 configured for a guidance of the containers 12 (cf. in particular exemplary embodiment of the distributor unit 32 in FIG. 4b), or wherein the distributor unit 32 comprises at least one storage element 36, which is supported movably, in particular pivotably, and which in at least one position of the storage element 36 interacts with an output element 38 of the distributor unit 32 (cf. in particular exemplary embodiment of the distributor unit 32 in FIGS. 2 and 4a). In FIG. 2 the distributor unit 32 illustrated in FIG. 4a is arranged in a container transport flow of the container-feeding device 10. The distributor unit 32 illustrated in FIG. 4b may be arranged in the container transport flow of the container-feeding device 10 alternatively to the distributor unit 32 shown in FIGS. 2 and 4a. The distributor unit 32, which is configured to divide up containers 12, in particular cup stacks, that are supplied via the unloading unit 22, is preferably arranged downstream of the unloading unit 22, viewed along the container transport flow. Viewed along the container transport flow, the unloading unit 22 is arranged downstream of the conveying unit 16 and upstream of the distributor unit 32.

The distributor unit 32 illustrated in FIG. 4a comprises at least the storage element 36 and the output element 38. Preferentially, in particular in an implementation of the distributor unit 32 in which the distributor unit 32 is preferably realized without chute elements 34, the storage element 36 is embodied as a lifting table. The storage element 36 that is embodied as a lifting table is preferably supported movably, in particular translationally movably, within the distributor unit 32, in particular within a frame of the distributor unit 32. The storage element 36 preferably forms a traversable bottom of a receiving space 80 of the distributor unit 32. The storage element 36 is preferably supported movably, in particular translationally movably, along a lifting axis 74 of the storage element 36 that runs at least substantially perpendicularly to the horizontal plane 56. Alternatively or additionally, the storage element 36 is supported such that it is pivotably movable, in particular around a pivot axis 76 of the storage element 36 that runs at least substantially parallel to the horizontal plane 56. In particular, the containers 12, in particular the cup stacks, can be fed, preferably directly, to the storage element 36 by means of the unloading unit 22. Preferably the containers 12, in particular the cup stacks, can be unloaded onto the storage element 36 by means of the unloading unit 22; preferably all containers 12, in particular cup stacks, can be unloaded from a single receiving container 20. The output element 38 is preferably realized as an output chute, in particular in the implementation of the distributor unit 32 illustrated in FIG. 4a. However, it is also conceivable that the output element 38 has a different implementation deemed expedient by someone skilled in the art, such as for example as an output lock or the like. In particular, at least one singulating element 78, preferably a singulating flap, of the distributor unit 32 is arranged on the output element 38. The singulating element 78 is preferably configured for individually discharging containers 12, in particular cup stacks, from the output element 38. Further implementations of the distributor unit 32, deemed expedient by someone skilled in the art, for a singulation of the containers 12, in particular the cup stacks, supplied by the unloading unit 22, are also conceivable.

In FIG. 4b, an alternative implementation of the distributor unit 32 is illustrated in which-in particular alternatively to the storage element 36 realized as a lifting table and to the output element 38 realized as an output chute-the distributor unit 32 comprises the plurality of chute elements 34. Preferentially the chute elements 34 are configured to delimit individual receiving spaces 80 of a plurality of receiving spaces 80 of the distributor unit 32, into which the containers 12, in particular the cup stacks, can be fed by the unloading unit 22. Preferably the containers 12, in particular the cup stacks, can be subdivided into individual stacks by means of the chute elements 34 already during an unloading by the unloading unit 22. Preferably the containers 12, in particular the cup stacks, can be stacked in the chute elements 34, in particular along a vertical axis 82 (cf. FIGS. 4a and 4b) of the distributor unit 32. Preferably in each chute element 34 a stack can be formed. In particular, the chute elements 34 can be closed or opened at least on one side, in particular on a side facing away from the unloading unit 22, by means of at least one singulating element 78, in particular a plurality of singulating elements 78. The singulating element 78 is preferably realized as a singulating flap. However, it is also conceivable that the singulating element 78 has a different implementation deemed expedient by someone skilled in the art, in particular an implementation by which containers 12, in particular cup stacks, can be transferred individually from the respective receiving space 80. The singulating elements 78 are preferably realized so as to be at least substantially identical to one another. In particular, the singulating element/s 78 is/are supported so as to be, in particular translationally and/or rotationally, movable relative to the chute elements 34. The singulating element/s 78 may be configured to delimit, preferably to predetermine, a stack length within the chute elements 34, in particular by a movability, preferably displaceability, of the singulating elements 78 along the vertical axis 82 relative to the chute elements 34. The chute elements 34 preferably comprise slot-link guide elements 84, in particular slot-link guide grooves, depending on which the singulating element/s 78 is/are movable, in particular pivotable. The singulating element/s 78 is/are preferably movable within the chute element/s 34, in particular via the slot-link guide elements 84, translationally along a direction that runs within the chute element/s 34 at least substantially perpendicularly to the conveying surface 42 of the conveying element/s 18. Preferably at least one, preferably two, singulating element/s 78 is/are allocated to each of the receiving spaces 80. In particular, the singulating element/s 78 and the chute element/s 34 together form something like a container lifting unit, in particular a cup stack lifting unit, by means of which the containers 12, in particular the cup stacks, can be moved in the distributor unit 32 along the vertical axis 82.

The container-feeding device 10 preferably comprises at least one bearing unit 40 (cf. FIGS. 2, 3a and 3b), in particular a linear bearing unit, for a movable, in particular translationally movable, support of the unloading unit 22, in particular along a movement axis 44 of the unloading unit 22 that runs at least substantially parallel to the conveying surface 42 of the conveying element/s 18, wherein the unloading unit 22 is supported by the bearing unit 40 such that it is movable at least from a loading position of the unloading unit 22 to an unloading position of the unloading unit 22. The bearing unit 40 preferably comprises at least one guide element 86, in particular at least one linear guide element, for guiding a movement of the unloading unit 22 relative to a frame of the container-feeding device 10 and/or relative to the conveying unit 16 along and/or around the movement axis 44 of the unloading unit 22. Preferably, in at least one implementation of the bearing unit 40, the guide element 86 is realized as a linear guide carriage. However, it is also conceivable that the guide element 86 has a different implementation deemed expedient by someone skilled in the art, in particular an implementation appropriate for a type of the movement that is to be guided, and/or that the bearing unit 40 has a plurality of guide elements 86. The bearing unit 40 is preferably configured for a conjoint movement of the holding element/s 24, 26 and the release element 28, preferably along the movement axis 44 of the unloading unit 22, in the horizontal plane 56, in particular for a movement of the unloading unit 22 from a position above the conveying element/s 18 and/or of the lifting unit 46 to a position above the distributor unit 32.

Preferably the container-feeding device 10 comprises at least the lifting unit 46 (cf. FIG. 2) which, in particular in at least one implementation of the container-feeding device 10, comprises at least one movably supported lifting element 50, which is configured to transfer the receiving container 20 from the conveying element 18 to the unloading unit 22, in particular to the holding element/s 24, 26. In particular, in at least one implementation of the container-feeding device 10, the lifting unit 46 is configured to movably support the entire unloading unit 22 along a vertical direction 48 for a transfer of the receiving container 20 from the conveying element 18 to the unloading unit 22, in particular to the holding element/s 24, 26 (schematically illustrated by a movement axis of the unloading unit 22 that is indicated in dashed lines in FIGS. 2, 3a and 3b and runs at least substantially perpendicularly to the horizontal plane 56).

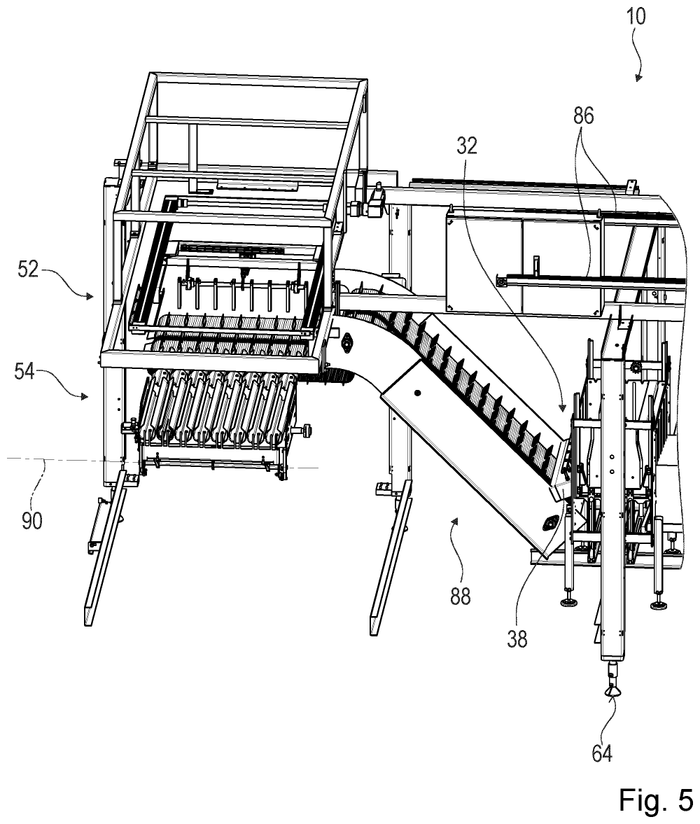

FIG. 5 shows an ascending conveying unit 88 of the container-feeding device 10 which is, viewed along the container transport flow of the container-feeding device 10, arranged downstream of the distributor unit 32, FIG. 5 further shows a feeding-conveying unit 52 of the container-feeding device 10 which is, viewed along the container transport flow of the container-feeding device 10, arranged downstream of the ascending conveying unit 88, and FIG. 5 also shows a magazine unit 54 of the container-feeding device 10 which is, viewed along the container transport flow of the container-feeding device 10, arranged downstream of the feeding-conveying unit 52. The magazine unit 54 is preferably supported movably, in particular pivotably, around a movement axis 90 of the magazine unit 54. The movement axis 90 of the magazine unit 54 preferably runs at least substantially parallel to the horizontal plane 56. The ascending conveying unit 88, the magazine unit 54 and/or the feeding-conveying unit 52 may have an implementation already known to someone skilled in the art. The metering and/or filling device 14 is preferably arranged downstream of the magazine unit 54, viewed along the container transport flow of the container-feeding device 10. The magazine unit 54 preferably transfers the containers 12, in particular the cup stacks, to the metering and/or filling device 14 for further processing in a manner already known to someone skilled in the art.

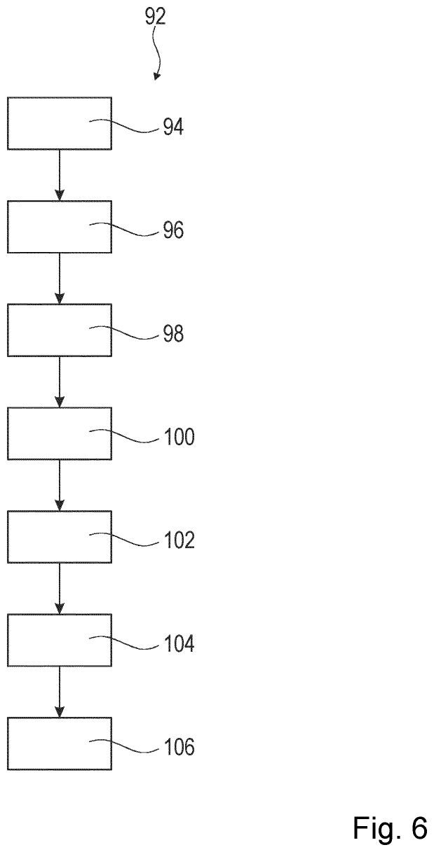

FIG. 6 shows a schematic process flow of a method 92 for feeding containers 12, in particular cup stacks, to the metering and/or filling device 14 by means of the container-feeding device 10. In particular, in at least one method step 94 of the method 92, preferably starting from a storage on a transport pallet, the receiving containers 20 are fed manually by an operator to the conveying unit 16, in particular to the conveying element/s 18. Alternatively or additionally, it is also conceivable that in the method step 94, preferably starting from a storage on a transport pallet, the receiving containers 20 are fed to the conveying unit 16 automatically by means of a handling unit, such as for example an, in particular multi-axis, robot arm or an autonomously acting robot or the like. Preferentially, in at least one method step 96 of the method 92, conveying of the receiving containers 20 towards the unloading unit 22 and/or towards the lifting unit 46 is realized. Preferably, in at least one method step 98 of the method 92, a singulation of the receiving containers 20 situated on the conveying element/s 18 is realized by means of the at least one stopper element 62 of the conveying unit 16. Preferably, in at least one method step 100 of the method 92, the receiving containers 20 are transferred to the unloading unit 22, in particular by the lifting unit 46. Preferentially, in at least one method step 102 of the method 92, the containers 12, in particular cup stacks, arranged in the receiving containers 20 are unloaded by means of the unloading unit 22. Preferably, in the method step 102, in particular as a result of the unloading by means of the unloading unit 22, a transfer of the containers 12, in particular cup stacks, to the distributor unit 32 is realized. Preferably, in the method step 102, by means of the unloading unit 22 of the container-feeding device 10, an at least partially, in particular completely, automatic unloading of the containers 12 from the receiving container 20 is realized at least by a rotational movement of the holding element 24, 26 of the unloading unit 22 that, in particular temporarily, holds the receiving container 20, and/or at least by a movement of the release element 28 of the unloading unit 22 that in at least one state covers the unloading opening 30 of the receiving container 20. Preferentially, at least in the method step 102, the unloading unit 22 is moved at least from the loading position of the unloading unit 22 to the unloading position of the unloading unit 22 by means of the bearing unit 40, in particular along the movement axis 44 of the unloading unit 22 that runs at least substantially parallel to the conveying surface 42 of the conveying element/s 18. Preferably, in at least one method step 104 of the method 92, the containers 12 supplied via the unloading unit 22 are divided up by means of the distributor unit 32, wherein as a result of an unloading by the unloading unit 22, the containers 12 are fed to the plurality of chute elements 34 of the distributor unit 32 which are configured for a guidance of the containers 12, or wherein after the unloading by the unloading unit 22, the containers 12 are fed to the output element 38 by means of at least the pivotably supported storage element 36 of the distributor unit 32. Preferably, in at least one method step 106 of the method 92, the containers 12 are fed by means of the feed conveying unit 52, in particular the transverse conveying unit, of the container-feeding device 10 to the magazine unit 54 of the container-feeding device 10, which, in particular subsequent to the feeding of the containers 12, is pivoted by more than 45° relative to the horizontal plane 56, in particular in order to transfer the containers 12 to the metering and/or filling device 14.

Further method steps of the method 92, such as for example a filling of the containers 12 by means of the metering and/or filling device 14, or other method steps deemed expedient by someone skilled in the art are also conceivable. In particular, further method steps of the method 92 may be derived from the description of FIGS. 1 to 5.

1. A container-feeding device for a feeding of containers (12) to a metering and/or filling device (14), the container-feeding device comprising:
at least one conveying unit (16), and
at least one unloading unit (22),
wherein the at least one conveying unit (16) comprises at least one conveying element (18) for conveying at least one receiving container (20) in which a plurality of containers (12) is arranged, wherein the at least one unloading unit (22) is configured for an at least partially automatic unloading of the containers (12) from the at least one receiving container (20) at least by a rotational movement of at least one rotatably supported holding element (24, 26) of the at least one unloading unit (22), which is configured for holding the at least one receiving container (20), and/or at least by a movement of a movably supported release element (28) of the at least one unloading unit (22), which is configured for a release of an unloading opening (30) of the at least one receiving container (20).

2. A-The container-feeding device according to claim 1, further comprising at least one distributor unit (32), which is configured to divide up containers (12) supplied via the at least one unloading unit (22), wherein the at least one distributor unit (32) comprises a plurality of chute elements (34) which are configured for a guidance of the containers (12), or wherein the at least one distributor unit (32) comprises at least one storage element (36), which is supported movably and which in at least one position of the at least one storage element (36) interacts with an output element (38) of the at least one distributor unit (32).

3. The container-feeding device according to claim 1, further comprising at least one bearing unit (40) for a movable support of the at least one unloading unit (22) along a movement axis (44) of the at least one unloading unit (22) that runs at least substantially parallel to a conveying surface (42) of the at least one conveying element (18), wherein the at least one unloading unit (22) is supported by the at least one bearing unit (40) such that it is movable at least from a loading position of the at least one unloading unit (22) to an unloading position of the at least one unloading unit (22).

4. The container-feeding device according to claim 1, further comprising at least one lifting unit (46), which is configured to movably support the at least one unloading unit (22) along a vertical direction (48) or which comprises at least one movably supported lifting element (50) configured to transfer the at least one receiving container (20) from the at least one conveying element (18) to the at least one holding element (24, 26).

5. The container-feeding device according to claim 1, further comprising at least one distributor unit (32), which is configured to divide up containers (12) supplied via the at least one unloading unit (22), wherein viewed along a container transport flow, the at least one unloading unit (22) is arranged downstream of the at least one conveying unit (16) and upstream of the at least one distributor unit (32).

6. A production machine with at least one metering and/or filling device and with at least one container-feeding device according to claim 1.

7. A method for feeding containers (12) to a metering and/or filling device (14) by a container-feeding device according to claim lone of claims 1, wherein in at least one method step (102), via the at least one unloading unit (22) of the container-feeding device, an at least partially automatic unloading of the containers (12) from the at least one receiving container (20) is realized at least by a rotational movement of the at least one holding element (24, 26) of the at least one unloading unit (22) that holds the at least one receiving container (20), and/or at least by a movement of the release element (28) of the at least one unloading unit (22) that in at least one state covers an unloading opening (30) of the at least one receiving container (20).

8. The method according to claim 7, wherein in at least one method step (104), the containers (12) supplied via the at least one unloading unit (22) are divided up by at least one distributor unit (32) of the container-feeding device, wherein as a result of an unloading by the at least one unloading unit (22), the containers (12) are fed to a plurality of chute elements (34) of the at least one distributor unit (32) which are configured for a guidance of the containers (12), or wherein after an unloading by the at least one unloading unit (22), the containers (12) are fed to an output element (38) of the at least one distributor unit (32) by at least one pivotably supported storage element (36) of the at least one distributor unit (32).

9. The method according to claim 7, wherein in at least one method step (102), the at least one unloading unit (22) is moved at least from a loading position of the at least one unloading unit (22) to an unloading position of the at least one unloading unit (22) by at least one bearing unit (40) along a movement axis (44) of the at least one unloading unit (22) that runs at least substantially parallel to a conveying surface (42) of the at least one conveying element (18).

10. The method according to claim 7, wherein in at least one method step (106), the containers (12) are fed by a feed conveying unit (52) of the container-feeding device to a magazine unit (54) of the container-feeding device, which is pivoted by more than 45° relative to a horizontal plane (56).

11. A container-feeding device for a feeding of containers (12) to a metering and/or filling device (14), the container-feeding device comprising:
at least one conveying unit (16), and
at least one distributor unit (32),
wherein the at least one conveying unit (16) comprises at least one conveying element (18) for conveying at least one receiving container (20) in which a plurality of containers (12) is arranged, wherein the at least one distributor unit (32) is configured to divide up containers (12) supplied via an unloading unit (22), wherein the at least one distributor unit (32) comprises a plurality of chute elements (34) which are configured for a guidance of the containers (12), or wherein the at least one distributor unit (32) comprises at least one storage element (36), which is supported movably and which in at least one position of the at least one storage element (36) interacts with an output element (38) of the at least one distributor unit (32).
